(19) United States
(12) Patent Application Publication
(10) Pub. No.: US 2019/0303110 A1
(43) Pub. Date: Oct. 3, 2019

(54) VIRTUAL REALITY INTEGRATED DEVELOPMENT ENVIRONMENT

(71) Applicant: CA, Inc., Islandia, NY (US)

(72) Inventor: Susan L. Brude, Pilot Point, TX (US)

(73) Assignee: CA, Inc., Islandia, NY (US)

(21) Appl. No.: 15/940,960

(22) Filed: Mar. 29, 2018

(51) Int. Cl. G06F 8/34; G06T 15/20; G06F 3/0481; G06F 3/0484; G06T 19/00

(52) U.S. Cl. CPC G06F 8/34; G06T 15/20; G06F 3/04815; G06F 3/04883; G06T 19/003; G06T 2210/36; G06F 3/04845

(57) ABSTRACT

In one embodiment, source code associated with a computing application is accessed, and based on an analysis of the source code, an application architecture associated with the computing application is identified, and a three-dimensional representation of the application architecture is generated. Moreover, a user perspective within a virtual reality system is identified based on an input from the virtual reality system. A virtual development environment for the computing application is generated and is further caused to be displayed by the virtual reality system, wherein the virtual development environment comprises a three-dimensional rendering of the computing application, and wherein the three-dimensional rendering is based on the three-dimensional representation of the application architecture and the user perspective within the virtual reality system.

### BACKGROUND

This disclosure relates in general to the field of computer and software development, and more particularly, though not exclusively, to a virtual reality integrated development environment.

As computing applications become increasingly sophisticated, their complexity similarly increases, along with the number and variety of underlying components. Moreover, developing and maintaining a complex computing application can be challenging, particularly due to the large number of underlying components, the complex relationships between those components, and the fact that many components are often developed by different developers, different development teams, and/or different development entities. Accordingly, it can be difficult for any one developer to fully understand the entire architecture and/or ecosystem of a highly complex computing application.

### BRIEF SUMMARY

According to one aspect of the present disclosure, source code associated with a computing application is accessed, and based on an analysis of the source code, an application architecture associated with the computing application is identified, and a three-dimensional representation of the application architecture is generated. Moreover, a user perspective within a virtual reality system is identified based on an input from the virtual reality system. A virtual development environment for the computing application is generated and is further caused to be displayed by the virtual reality system, wherein the virtual development environment comprises a three-dimensional rendering of the computing application, and wherein the three-dimensional rendering is based on the three-dimensional representation of the application architecture and the user perspective within the virtual reality system.

### BRIEF DESCRIPTION OF THE DRAWINGS

FIG. 1 illustrates an example computing environment with a virtual reality development system.

FIG. 2 illustrates an example embodiment of a virtual reality development system.

FIG. 3 illustrates the architecture of an example software application.

FIGS. 4A-F illustrate examples of a virtual reality software development interface.

FIG. 5 illustrates a flowchart for an example embodiment of a virtual reality development system.

### DETAILED DESCRIPTION OF EXAMPLE EMBODIMENTS

As will be appreciated by one skilled in the art, aspects of the present disclosure may be illustrated and described herein in any of a number of patentable classes or contexts, including any new and useful process, machine, manufacture, or composition of matter, or any new and useful improvement thereof. Accordingly, aspects of the present disclosure may be implemented entirely as hardware, entirely as software (including firmware, resident software, micro-code, etc.), or as a combination of software and hardware implementations, all of which may generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain or store a program for use by, or in connection with, an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider), or in a cloud computing environment, or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses, or other devices, to produce a computer implemented process such that the instructions which execute on the computer or other programmable apparatus provide processes for implementing the functions/acts specified in the flowchart and/or block diagram block or blocks.

Example embodiments that may be used to implement the features and functionality of this disclosure will now be described with more particular reference to the attached FIGURES.

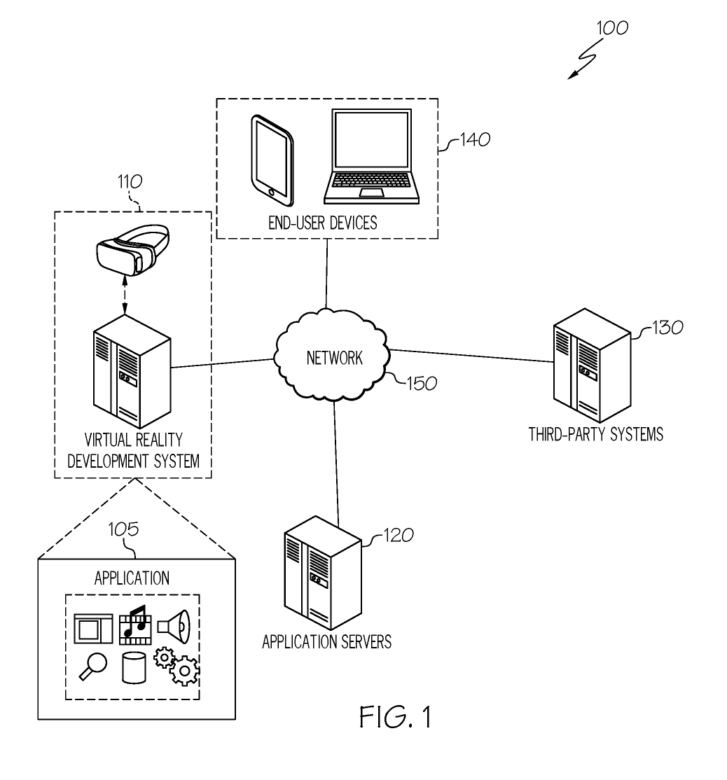

FIG. 1 illustrates an example computing environment 100 with a virtual reality (VR) development system 110. In some embodiments, for example, VR development system 110 may provide a virtual reality (VR) environment for developing complex software and/or computing applications 105, as described further below.

In the illustrated embodiment, for example, computing environment 100 may be used to host and/or deploy computing applications, such as application 105. Application 105, for example, may include any type of software or computing components, such as a software application, program, library, module, and/or any portion or component of a larger, multi-tiered software system, among other examples. Moreover, application 105 may be deployed, hosted, and/or executed in computing environment 100. In the illustrated embodiment, for example, application 105 may be hosted or deployed on one or more application servers 120 of computing environment 100. Moreover, application 105 may be designed to communicate or interact with other components of computing environment 100 (e.g., third-party systems 130 and/or end-user devices 140) via network 150. In some embodiments, for example, application 105 may be a web-services application designed to interact with a variety of end-user devices 140 (e.g., mobile devices, laptops, desktops) and/or other third-party systems 130 in communication environment 100.

As software applications (e.g., application 105) become more sophisticated, their complexity also increases, along with the number and variety of underlying components. Accordingly, developing and maintaining complex software applications using traditional development tools and methods can be challenging, particularly when the number of underlying components is large, the relationships between those components are complex, and many components are developed by different developers, development teams, and development entities.

Today, software development typically focuses only a small amount on the code right in front of a developer that is being worked on at the time. Rather, much of the work involves understanding how that code fits into the larger ecosystem of the current project, including other code from the current project that other developers are writing, other projects that the current project relies on, and/or other projects that rely on the current project. Naturally, visualizing these relationships can be challenging. For example, it can be difficult for any one developer to fully understand the entire architecture or ecosystem of a highly complex software application, particularly when each developer handles development of only a small portion of the overall functionality of the application. This can result in a developer writing code that does not “fit” or interoperate well with other components of the broader application architecture or ecosystem, particularly when it is difficult to determine how those components interface and interact with the code that is currently under development.

Further, traditional integrated development environments (IDEs) struggle to provide adequate visualization tools for assisting developers in understanding how any given component fits within the broader architecture or ecosystem of a particular project. For example, traditional IDEs may include tools to identify the structure of a complex project, identify relationships between the underlying components, and/or monitor and track how the underlying components interact with each other. The complex code written by developers these days is not two-dimensional (2D), however, and traditional IDEs with simple graphical interfaces are simply ineffective for visualizing complex code in a manner that is useful for software developers. For example, due to the numerous components and complex relationships of a typical large-scale project, visualization of the project using traditional IDEs (e.g., using only two-dimensions, a limited viewing area, and/or a single screen) is simply ineffective.

Accordingly, in the illustrated embodiment, virtual reality (VR) development system 110 provides a virtual reality (VR) environment to facilitate the development of complex software and/or computing applications (e.g., application 105) in computing environment 100. In general, recent advancements in VR technology have made the technology more accessible, but there are very few applications of VR outside of the gaming world. VR technology, however, can provide numerous benefits when leveraged for software and computer development. In the illustrated embodiment, for example, VR development system 110 provides a virtual reality (VR) environment with an integrated development environment (IDE) for software developers. In this manner, the virtual reality IDE allows developers to visualize, navigate, develop, and test complex computing applications in a three-dimensional (3D) VR environment.

In some embodiments, for example, the virtual reality IDE may visualize a complex computing application by displaying a 3D graph of its overall architecture or ecosystem, which may be seamlessly explored and inspected in a VR environment by a developer. Further, as the developer interacts with the application in the VR environment (e.g., inspecting certain components, writing code, performing testing and debugging), the virtual reality IDE may visualize certain aspects of the application and its underlying components in real time, such as software dependencies or runtime interactions between components, among other examples. As an analogy, the virtual reality IDE may visualize an application in a manner that resembles activity in a nervous system, which consists of a network of neurons that transmit signals to each other via connections referred to as synapses.

In this manner, developers can use the virtual reality IDE to visualize and navigate through the underlying components, code, and relationships (e.g., inter/intra software dependencies) of a complex software solution in a 3D VR environment. For example, using a VR headset, a developer may look around the VR environment to view different portions of the architecture or ecosystem of the application, and the virtual reality IDE may display different types of information with varying levels of detail based on the circumstances, such as where the developer is currently looking and/or the task or activity that the developer is currently performing. The developer may also use a VR controller (e.g., a handheld motion tracking controller or glove) to further navigate through and/or select certain portions of the architecture or ecosystem of the application. In some cases, for example, the developer may select certain portions of the application architecture to obtain additional information about certain components of the application and/or their respective relationships.

The virtual reality IDE may also allow developers to actively develop and write code for an application, and perform any associated testing and debugging, directly within the VR environment. For example, a developer may inspect, edit, and/or write source code from within the VR environment (e.g., using the VR controller, a virtual keyboard, and/or voice recognition) by selecting an existing component or creating a new component using the virtual reality IDE. Moreover, as a developer writes or inspects code from within the VR environment, the virtual reality IDE may display visual indications in real time that show how the code impacts other portions of the application or its overall architecture. In this manner, a developer can walk through existing code and/or write new code, see pathways and relationships of components associated with that code, and see how the code impacts the overall solution in real time (e.g., as the code is being written or inspected by the developer), reaching even external to the particular application or project. As an example, when a developer writes code that defines new variables or calls certain methods or functions, the virtual reality IDE may highlight or emphasize portions of the overall architecture or ecosystem that are impacted by that code (e.g., in the developer's peripheral vision outside of the active coding window), thus providing the developer with visual indications of the potential effects of the developer's coding decisions.

Similarly, developers may also test and debug applications directly within the VR environment. For example, the virtual reality IDE may allow a developer to execute or simulate an application (or specific components or code associated with the application) inside the VR environment. Moreover, the virtual reality IDE may visualize execution of the application in real time, such as by displaying visual indications of the call flow and/or interactions between underlying components of the application during execution.

In this manner, the virtual reality IDE can be used by developers to streamline any or all cycles of the software development process. In some cases, the virtual reality IDE may either supplement traditional IDEs (e.g., for certain development tasks) or replace them altogether. Further, the virtual reality IDE is particularly beneficial for developing large-scale computing applications and systems, which typically involves large teams of developers that collaborate to develop complex combinations of native code in conjunction with interfaces to other external code, components, and/or systems. In particular, the virtual reality IDE allows these developers to easily visualize and understand the relationship between the code they respectively develop and the overall architecture and ecosystem of the application, which ultimately helps the developers write high-performance and bug-free code for the application in a more efficient manner. The virtual reality IDE can also improve collaboration among developers, as multiple developers can participate in a shared VR development environment and/or communicate with each other while immersed in the VR development environment(s). Moreover, the virtual reality IDE may ultimately enhance the skillset of certain developers, as well as attract new developers by generally increasing the interest in software development.

Further, the virtual reality IDE may be similarly adapted for other types of computer development and design, such as the development of computer hardware (e.g., integrated circuits, processors, microprocessors) using a hardware description language (HDL) (e.g., VHDL, Verilog), among other examples.

Additional details and embodiments associated with the virtual reality IDE are described throughout this disclosure in connection with the remaining FIGURES.

In general, elements of computing environment 100, such as “systems,” “servers,” “services,” “devices,” “clients,” “networks,” “computers,” and any components thereof, may be used interchangeably herein and refer to computing devices operable to receive, transmit, process, store, or manage data and information associated with computing environment 100. Moreover, as used in this disclosure, the term “computer,” “processor,” “processor device,” or “processing device” is intended to encompass any suitable processing device. For example, elements shown as single devices within computing environment 100 may be implemented using a plurality of computing devices and processors, such as server pools comprising multiple server computers. Further, any, all, or some of the computing devices may be adapted to execute any operating system, including Linux, other UNIX variants, Microsoft Windows, Windows Server, Mac OS, Apple iOS, Google Android, etc., as well as virtual machines adapted to virtualize execution of a particular operating system, including customized and/or proprietary operating systems.

Moreover, elements of computing environment 100 (e.g., VR development system 110, application servers 120, third-party systems 130, end-user devices 140, network 150, etc.) may each include one or more processors, computer-readable memory, and one or more interfaces, among other features and hardware. Servers may include any suitable software component or module, or computing device(s) capable of hosting and/or serving software applications and services, including distributed, enterprise, or cloud-based software applications, data, and services. For instance, one or more of the described components of computing environment 100, may be at least partially (or wholly) cloud-implemented, “fog”-implemented, web-based, or distributed for remotely hosting, serving, or otherwise managing data, software services, and applications that interface, coordinate with, depend on, or are used by other components of computing environment 100. In some instances, elements of computing environment 100 may be implemented as some combination of components hosted on a common computing system, server, server pool, or cloud computing environment, and that share computing resources, including shared memory, processors, and interfaces.

Further, the network(s) 150 used to communicatively couple the components of computing environment 100 may be implemented using any suitable computer communication or network technology for facilitating communication between the participating components. For example, one or a combination of local area networks, wide area networks, public networks, the Internet, cellular networks, Wi-Fi networks, short-range networks (e.g., Bluetooth or ZigBee), and/or any other wired or wireless communication medium may be utilized for communication between the participating devices, among other examples.

While FIG. 1 is described as containing or being associated with a plurality of elements, not all elements illustrated within computing environment 100 of FIG. 1 may be utilized in each alternative implementation of the embodiments of this disclosure. Additionally, one or more of the elements described in connection with the examples of FIG. 1 may be located external to computing environment 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

Additional embodiments and functionality associated with the implementation of computing environment 100 are described further in connection with the remaining FIGURES. Accordingly, it should be appreciated that computing environment 100 of FIG. 1 may be implemented with any aspects or functionality of the embodiments described throughout this disclosure.

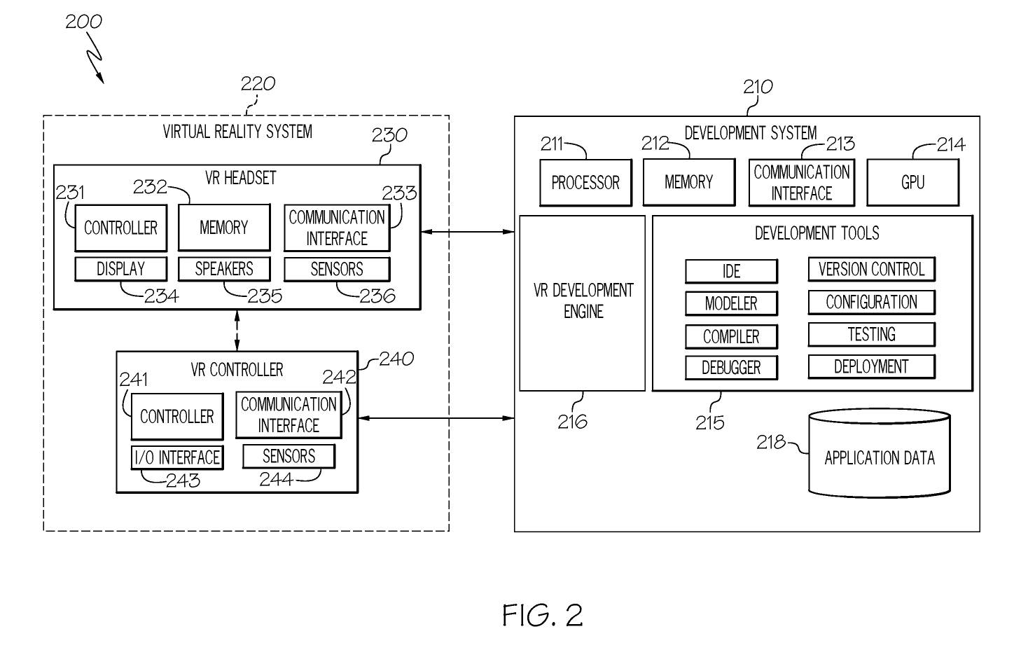

FIG. 2 illustrates an example embodiment of a virtual reality development system 200. In some embodiments, for example, virtual reality development system 200 may be used to implement the functionality of virtual reality development system 110 of FIG. 1.

In the illustrated embodiment, virtual reality (VR) development system 200 includes development system 210 and virtual reality (VR) system 220. Development system 210 is a computing system used for software development and is capable of providing a VR environment for software developers on VR system 220. For example, development system 210 can generate a VR environment with an integrated development environment (IDE) for software development, which can then be displayed on VR system 220 and used by a software developer to facilitate the development of complex software and/or computing applications, as described further below.

Development system 210 includes one or more processors 211, memory elements 212, communication interfaces 213, and graphics processing units (GPUs) 214, along with a collection of development tools 215, a virtual reality (VR) development engine 216, and an application data storage 218. Moreover, virtual reality (VR) system 220 includes VR headset 230 and one or more VR controllers 240. VR headset 230 includes one or more controllers or processors 231, memory elements 232, communication interfaces 233, displays 234, speakers 235, and sensors 236. Further, VR controller 240 includes one or more controllers or processors 241, communication interfaces 242, input/output (I/O) interfaces 243, and sensors 244.

Although VR development system 200 is implemented using a VR headset 230 and VR controller 240 in the illustrated embodiment, other embodiments may be implemented using any virtual reality (VR) form factors (which may or may not include VR headsets and/or VR controllers), such as external VR displays or monitors, VR booths, VR projectors, external VR cameras and sensors (e.g., to detect movement and gestures), and so forth.

In some implementations, the various illustrated components of VR development system 200, and/or any other associated components, may be combined, or even further divided and distributed among multiple different systems. For example, in some implementations, development system 210, virtual reality system 220, virtual reality headset 230, and/or VR controller 240 may be integrated or combined into the same component, device, or system. For example, in some embodiments, development system 210 may be integrated within VR headset 230. Alternatively, in some implementations, development system 210 may be implemented as multiple distinct and/or distributed development systems with varying combinations of its underlying components (e.g., 211-218). Further, components of VR development system 200 may communicate, interoperate, and otherwise interact with external systems and components, and with each other in distributed embodiments, over one or more communication mediums or networks using their respective communication interfaces (e.g., 213, 233, and 242).

In the illustrated embodiment, development system 210 includes a collection of software development tools 215, including an integrated development environment (IDE), version control system, application modeler and configuration manager, compiler, debugger, testing module, and deployment manager. The integrated development environment (IDE) is a tool that provides a comprehensive development environment for software developers, which may include an interface that provides integrated access to the various software development tools 215 of development system 210.

In the illustrated embodiment, development system 210 further includes virtual reality (VR) development engine 216, which implements the capabilities of an IDE in a three-dimensional (3D) virtual reality environment. In particular, VR development engine 216 can generate or render a virtual reality (VR) environment that visualizes a software application and provides access to comprehensive software development capabilities. In some embodiments, for example, VR development engine 216 may visualize a software application based on its associated application data 218, such as source code and/or configuration files, among other examples. For example, VR development engine 216 may analyze the associated application data 218 to determine the overall architecture and ecosystem of the application, and VR development engine 216 may then generate a 3D representation of the application based on its overall architecture. In this manner, VR development engine 216 can then generate a VR environment, which contains a visualization of the application and provides comprehensive software development capabilities based on a developer's interactions within the VR environment. For example, functionality associated with the various software development tools 215 may be accessible within the VR environment based on the developer's interactions, and/or through various icons and/or menus in the virtual environment.

In the illustrated embodiment, for example, the VR environment is continuously rendered by VR development engine 216 and further streamed to VR headset 230 (e.g., via the respective communication interfaces 213 and 233 of development system 210 and VR headset 230), causing VR headset 230 to display the VR environment to a particular user or developer wearing the headset. Moreover, the particular user or developer can interact with the VR environment using VR headset 230 and/or VR controller 240.

For example, VR headset 230 and VR controller 240 may include sensors 236, 244 for tracking their own movement and orientation and/or that of the developer. Moreover, in some embodiments, VR headset 230 may include a microphone as one of its sensors 236 in order to capture voice communications or commands from the developer. Further, VR controller 240 may additionally or alternatively include an I/O interface 243 with one or more physical buttons or controls that are accessible to the developer. In various embodiments, for example, VR controller 240 may be any type of device that can be held, worn, and/or otherwise interacted with by the developer, such as a handheld and/or motion tracking controller, motion tracking glove, keyboard, mouse, and so forth.

Accordingly, the head movement and orientation of the developer, potentially along with certain bodily movements, voice communications, and/or controller interactions, are continuously tracked by VR system 220 using VR headset 230 and/or VR controller 240. Further, VR system 220 continuously communicates this information to development system 210, which uses the information as input to VR development engine 216. In this manner, based on the input from VR system 220, VR development engine 216 can detect the developer's interactions within the VR environment, such as any movement, gestures, controller interactions, and/or voice commands from the developer, and VR development engine 216 can then update the VR environment appropriately based on the developer's interactions.

For example, as VR headset 230 tracks the developer's head movement and orientation, VR development engine 216 updates the VR environment to reflect the developer's current perspective, thus allowing the developer to look around the VR environment to view different portions of the architecture or ecosystem of the application. Further, VR development engine 216 may update the VR environment with different types of information and varying levels of detail depending on the context, such as where the developer is currently looking and/or the task or activity that the developer is currently performing. VR development engine 216 may also update the VR environment based on the developer's interactions using VR controller 240. For example, the developer may use VR controller 240 to further navigate through, select, and/or interact with certain portions of the architecture or ecosystem of the application, including develop and write code, execute code, perform testing and debugging, and so forth. In some embodiments, for example, VR controller 240 may include a motion tracking handheld controller or glove that allows the developer to interact within the VR environment using hand motions and gestures (e.g., touch, tap, point, grab, pinch, and/or swipe gestures, with multi-finger and single- or double-click variations, among other examples). Further, in some embodiments, the developer may also interact within the VR environment via the microphone of VR headset 230, such as using voice commands to select certain components, navigate to certain portions of the application architecture, edit source code, execute, test, and debug certain code, and so forth. Accordingly, VR development engine 216 may further update the VR environment based on any voice commands from the developer. Further, as the developer interacts with the application in the VR environment (e.g., inspecting certain components, writing code, performing testing and debugging), VR development engine 216 may update the VR environment to visualize certain aspects of the application and its underlying components in real time, such as software dependencies, call flows, and/or runtime interactions between components, among other examples.

Moreover, in some embodiments, VR development system 200 may allow multiple developers to simultaneously collaborate on the development of an application in a VR environment. For example, VR development system 200 may include multiple VR systems 220 for the various developers, such that each developer has its own VR system 220. In some embodiments, the VR systems 220 may share the same development system 210, or alternatively, each VR system 220 may have its own corresponding development system 210, and the respective development systems 210 may communicate with each other. In this manner, the respective developers can simultaneously collaborate on the development of an application in a shared VR environment via their respective VR systems 220, and the developers may also communicate with each other while immersed in the VR environment (e.g., via a microphone on their respective VR headsets 230). Further, in some embodiments, the developers can choose to independently navigate the shared VR environment via their respective VR systems 220, or a developer may choose to mirror the perspective of another developer. In this manner, VR development system 200 can greatly improve collaboration among developers.

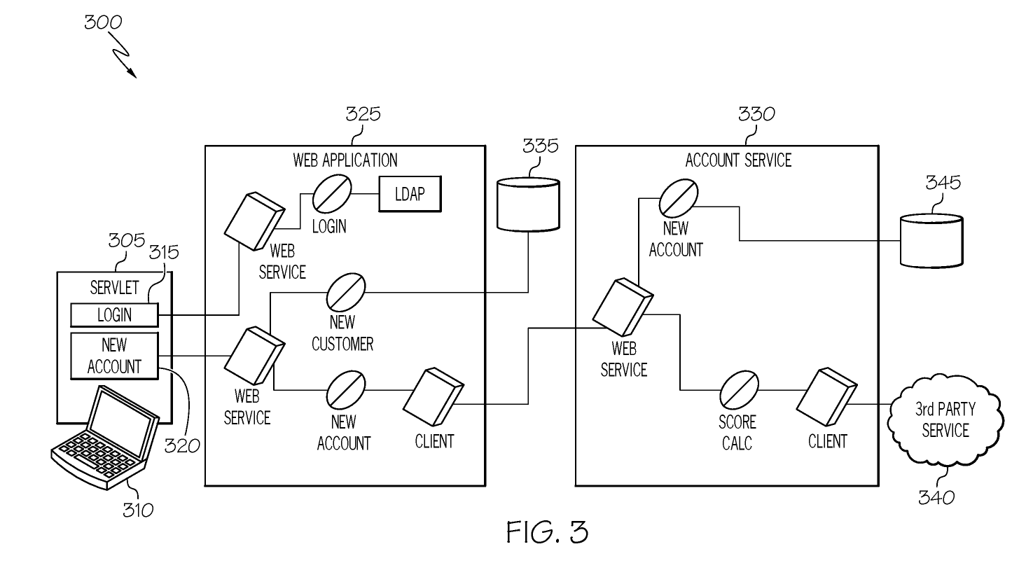

FIG. 3 illustrates the architecture 300 of an example software application used for e-commerce. In the illustrated example, architecture 300 includes an end-user or client device 310, a web application 325, an account service 330, a third-party service 340, and various databases 335, 345.

End-user device 310 includes a servlet 305 with software components 315, 320 for logging in and creating a new account for an e-commerce service. The components of servlet 305 (e.g., login component 315 and new account component 320) communicate with web application 325, and in turn, web application 325 may communicate with account service 330, third party service 340, and/or databases 335, 345, either directly or indirectly.

For example, for a login transaction, the login component 315 of servlet 305 accesses a web service component of web application 325, and the web service component in turn accesses a server-side login component and a Lightweight Directory Access Protocol (LDAP) component of web application 325 in order to log the user into to the e-commerce system.

For a new account transaction, the new account component 320 of servlet 305 accesses another web service component of web application 325, and that web services component separately accesses both a new customer component and a new account component of web application 325. The new customer component of web application 325 creates a new entry in a customer database 335, which is used to store information about the new customer. The new account component of web application 325 accesses a client interface that enables web application 325 to communicate with account service 330 in order to create a new account. For example, the client interface of web application 325 accesses a web service component of account service 330, and in turn, that web service component separately accesses both a credit score calculator and a new account component of account service 330. The credit score calculator of account service 330 accesses a client interface that enables account service 330 to communicate with a third-party credit reporting service 340, which provides credit information for the customer associated with the new account. The credit score calculator then uses the credit information obtained from the third-party service 340 to calculate a credit score for the customer associated with the new account. Finally, the new account component of account service 330 creates a new entry in a customer account database 345, which is used to store account information associated with the newly created account.

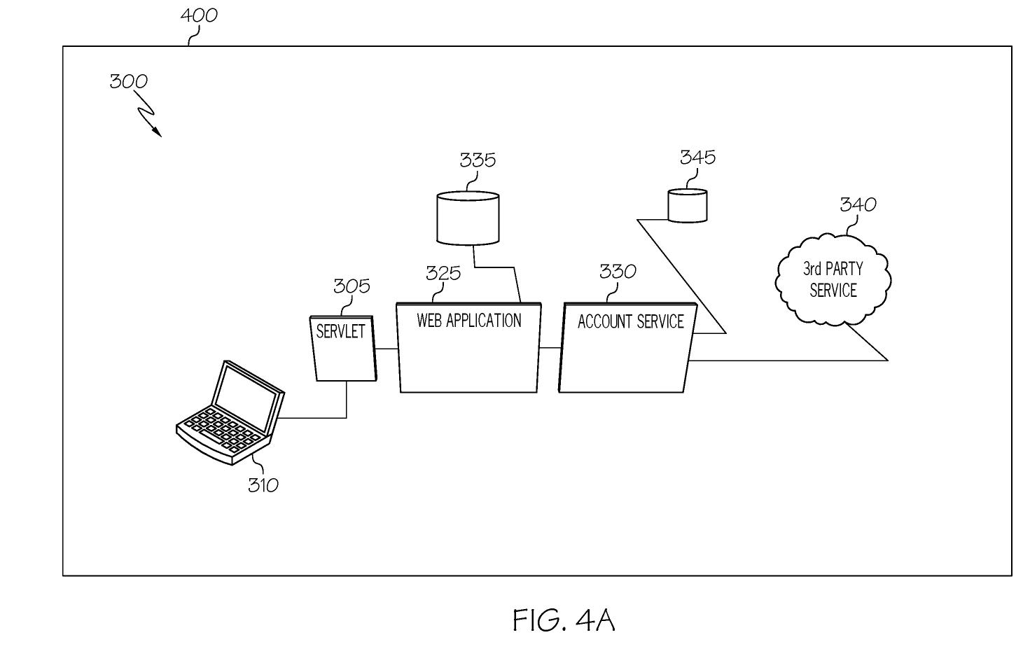

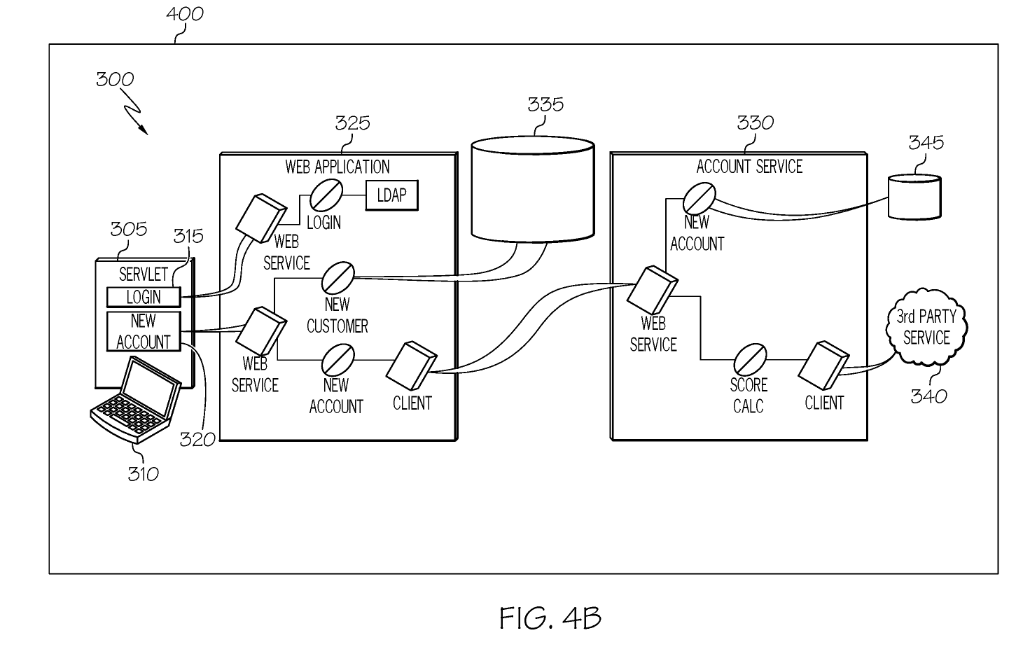

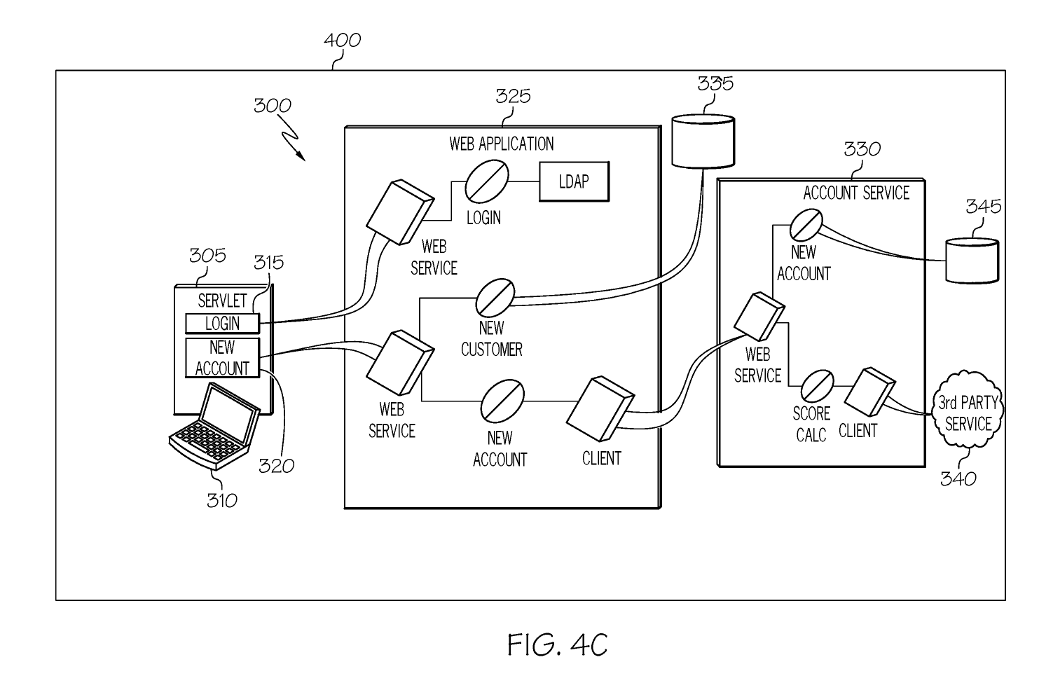

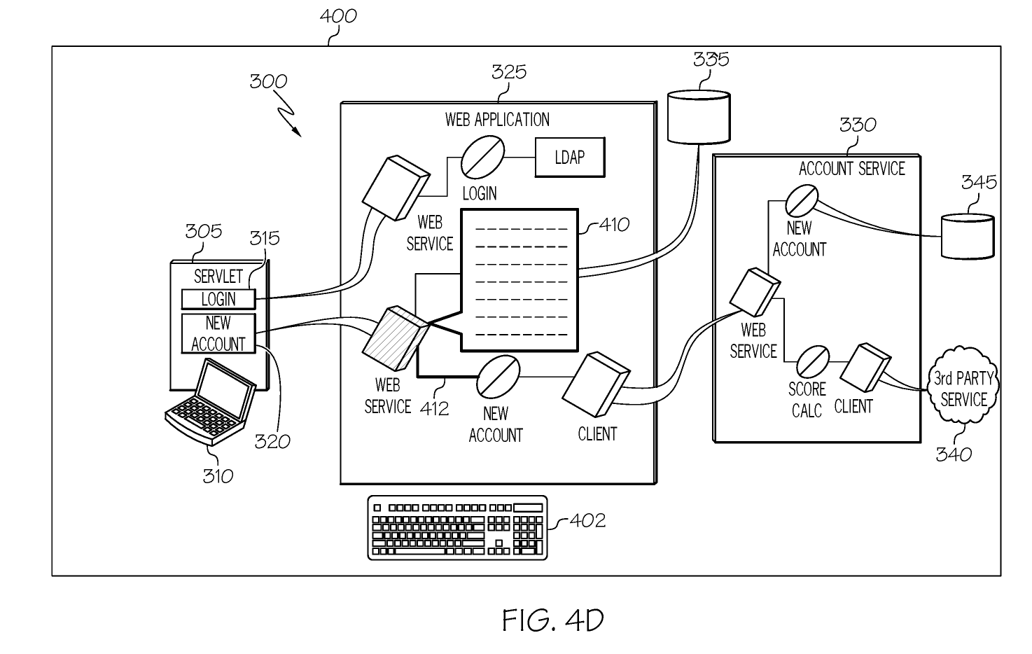

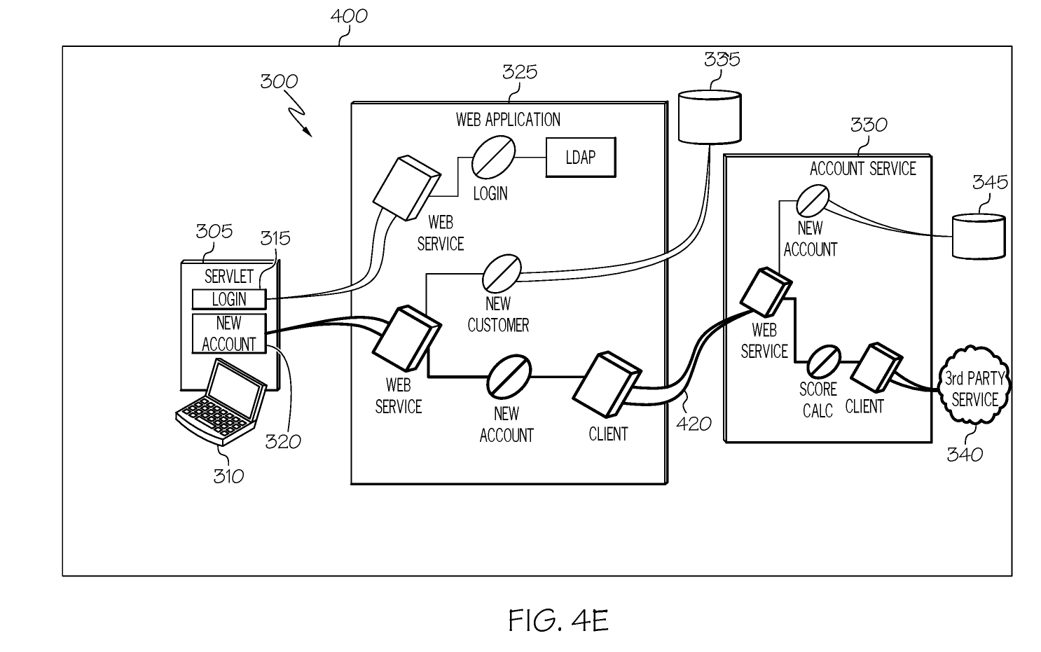

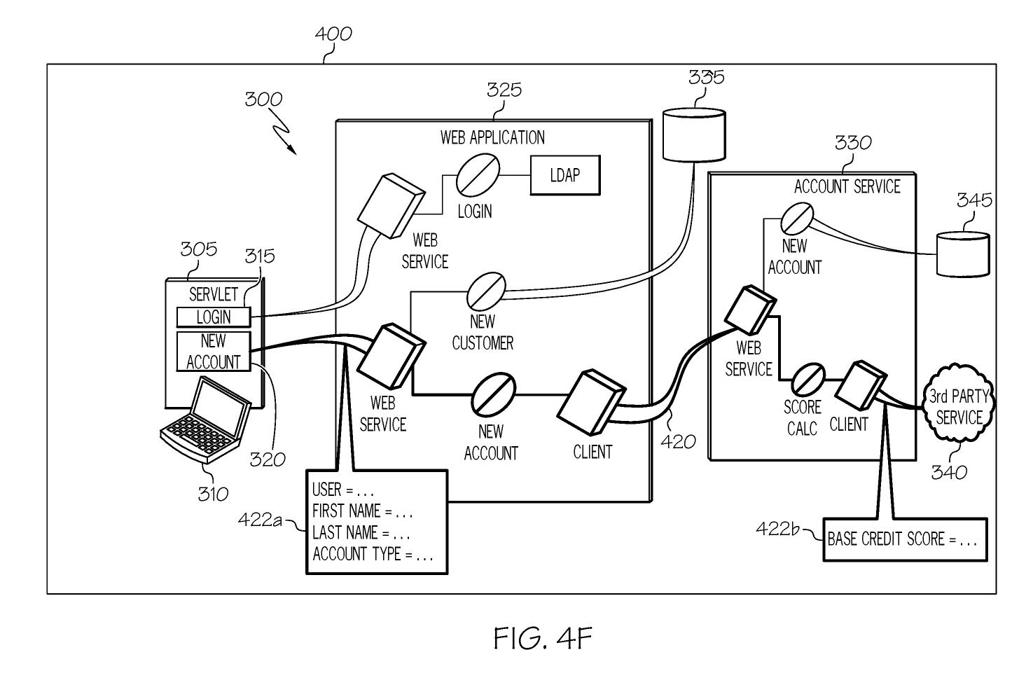

FIGS. 4A-F illustrate examples of a virtual reality (VR) software development interface 400. In the illustrated examples, VR interface 400 is used for the development of the example software application 300 from FIG. 3.

Initially, when a user or developer begins a VR development session for software application 300, VR interface 400 may display a high-level perspective of the overall architecture of software application 300, as shown in FIG. 4A. For example, VR interface 400 may display various software and/or hardware components associated with the architecture of software application 300 (both internal and external to the application itself), along with the relationships between those components (e.g., software dependencies, communication interfaces), among other examples.

The user or developer, however, may zoom in or out on VR interface 400 to see more or less detail about software application 300 (e.g., using pinch or touch gestures, voice commands, and/or VR controller buttons). For example, if the user zooms in, VR interface 400 may display additional information about servlet 305, web application 325, and account service 330 of application 300, as shown in FIG. 4B. The user may also navigate to specific components of software application 300 (e.g., using point or swipe gestures, voice commands, and/or VR controller buttons). For example, if the user navigates to web application 325, VR interface 400 may display web application 325 in the center of the screen, as shown in FIG. 4C.

The user may also inspect, edit, and/or write source code for a particular component of software application 300 (e.g., using point, touch, or tap gestures, voice commands, and/or VR controller buttons). For example, if the user selects a web service component of web application 325, VR interface 400 may display the source code 410 for that component, along with a virtual keyboard 402 that allows the user to edit the source code, as shown in FIG. 4D. Moreover, as the user edits or writes code, VR interface 400 may display a visual indication of the impact of that code on the application architecture. For example, if code written by the user for the web service component has an impact on, or a relationship with, the new account component, VR interface 400 may highlight or emphasize the relationship 412 between those respective components as the code is being written, as shown in FIG. 4D.

Further, the user may also execute, test, and/or debug software application 300 (e.g., using voice commands, gestures, and/or VR controller buttons). For example, if the user issues a command to execute or test software application 300, VR interface 400 may cause application 300 to be executed and/or simulated, and VR interface 400 may then visualize execution of application 300 in real time, such as by displaying visual indications of the call flow 420 and/or interactions between underlying components during execution, as shown in FIG. 4E. In some embodiments, the user may also pause, rewind, fast forward, and/or replay the visualized execution of application 300, set breakpoints at certain portions of the call flow and/or source code, bookmark the current perspective for quick-access at a later time, and so forth (e.g., using gestures, voice commands, and/or VR controller buttons).

Further, the user may also select particular interactions and/or transactions of the call flow 420 to obtain additional runtime information. For example, if the user selects certain runtime transactions 422 between components of application 300, VR interface 400 may display the underlying data or contents of those transactions 422a,b, as shown in FIG. 4F.

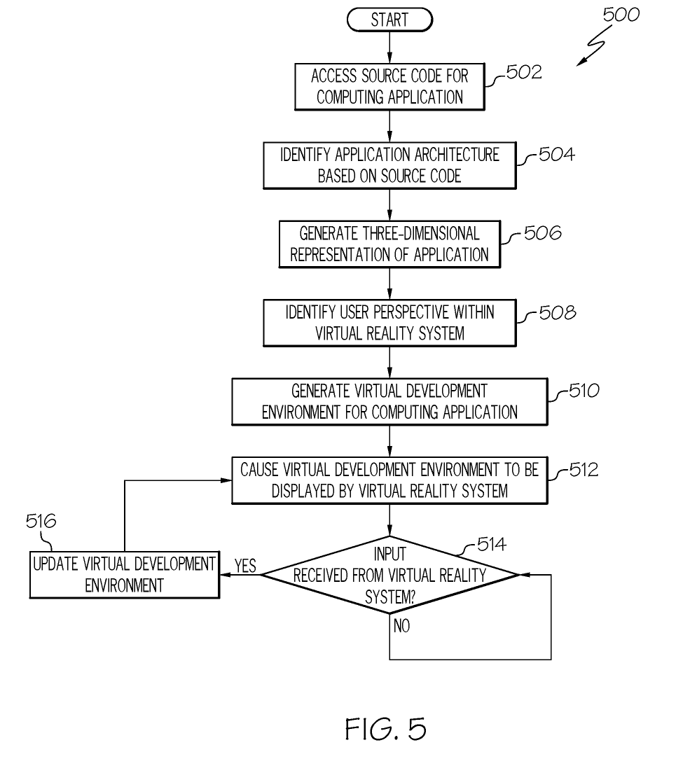

FIG. 5 illustrates a flowchart 500 for an example embodiment of a virtual reality development system. In some embodiments, flowchart 500 may be implemented using the embodiments and functionality described throughout this disclosure (e.g., computing environment 100 of FIG. 1 and/or virtual reality development system 200 of FIG. 2).

The flowchart may begin at block 502 by accessing the source code associated with a computing application. The computing application, for example, may include any type of software component that can be executed by one or more processors.

The flowchart may then proceed to block 504 to identify the application architecture of the computing application based on the source code. In some embodiments, for example, the source code of the computing application may be analyzed (possibly along with other configuration files or application data) to determine the overall architecture and ecosystem of the computing application.

For example, the source code of the computing application may include a combination of native software components or code, third-party software components or code (e.g., third-party software libraries, frameworks, application programming interfaces (APIs)), and/or interfaces to external components (e.g., external software or hardware components of third parties, such as cloud service providers, clients, and/or end-users), among other examples. Accordingly, the source code can be analyzed to determine the overall architecture and ecosystem of the computing application. For example, the overall application architecture may include a collection of software and/or hardware components (both internal and external to the computing application itself), along with various types of relationships between those components (e.g., software dependencies, communication interfaces, call flows and runtime interactions).

The flowchart may then proceed to block 506 to generate a three-dimensional representation of the application architecture. In some embodiments, for example, the application architecture may be represented using a three-dimensional graph of its underlying components and their associated relationships.

The flowchart may then proceed to block 508 to identify a user perspective within a virtual reality system. The virtual reality system, for example, may include a virtual reality headset that can be worn by a particular user or developer, along with one or more virtual reality controllers that the user or developer can interact with. Moreover, the virtual reality headset and/or controller may be capable of tracking the orientation, movement, and actions of the associated user, possibly along with other types of information.

In this manner, the various types of information tracked by the virtual reality system can be used to identify the user's perspective within the virtual reality system. For example, in some embodiments, a host development system may identify a user perspective within the virtual reality system based on one or more inputs from the virtual reality system, which may indicate the various types of information tracked by the virtual reality system.

The flowchart may then proceed to block 510 to generate a virtual development environment for the computing application. In some embodiments, for example, the virtual development environment may be a virtual reality environment containing a three-dimensional rendering of the computing application, which may be generated based on the three-dimensional representation of the application architecture, along with the current user perspective within the virtual reality system.

For example, the three-dimensional rendering of the computing application may contain a visual representation of some or all of the application architecture, such as the underlying components and their associated relationships (e.g., software dependencies, communication interfaces, call flows and runtime interactions).

Further, the level of detail associated with the computing application to be displayed in the virtual development environment may vary for different portions of the application architecture based on the user perspective. In particular, the virtual development environment may contain a greater level of detail for portions of the application architecture that appear closer to the user perspective, and a lesser level of detail for portions of the application architecture that appear further from the user perspective. Accordingly, in some embodiments, the virtual development environment may be generated by first determining the appropriate level of detail to display for the various portions of the application architecture, and then generating the three-dimensional rendering of the computing application with the appropriate level of detail.

The flowchart may then proceed to block 512 to cause the virtual development environment to be displayed by the virtual reality system. In some embodiments, for example, the host system may provide or otherwise transmit the rendering of the virtual development environment to the virtual reality system, causing the virtual reality system to display the virtual development environment (e.g., on the virtual reality headset).

The flowchart may then proceed to block 514 to determine whether any input has been received from the virtual reality system. For example, as described above, the virtual reality system may track various types of information associated with the user (e.g., the orientation, movement, and/or actions of the user), and that information may be provided, obtained, or otherwise identified based on one or more inputs from the virtual reality system. In this manner, the information tracked by the virtual reality system can subsequently be used to update the virtual development environment (e.g., in response to the user's interactions within the virtual environment). Accordingly, at block 514, it is determined whether any new input has been received from the virtual reality system that needs to be processed for the purpose of updating the virtual development environment.

If it is determined at block 514 that no new input has been received from the virtual reality system, the flowchart may remain at block 514 until new input is received from the virtual reality system, or alternatively, the flowchart may terminate if the development session has ended.

If it is determined at block 514 that new input has been received from the virtual reality system, the flowchart may proceed to block 516 to update the virtual development environment based on the input from the virtual reality system. For example, the input from the virtual reality system may be used to identify the user's interactions within the virtual development environment, such as determining when the user's perspective changes within the virtual reality system, detecting gestures and other actions of the user, and so forth. In this manner, the virtual development environment can then be updated in response to the user's interactions.

In some embodiments, for example, a user gesture may be detected that is associated with zooming in or out on the application architecture, navigating to a particular portion of the application architecture, selecting a particular software or hardware component of the application architecture, inspecting or editing source code, executing the computing application and/or certain code, selecting a particular call flow transaction during execution, and so forth.

The virtual development environment can then be updated based on the detected user gesture. In some cases, for example, the user perspective within the virtual reality system may be updated based on the user gesture (e.g., to zoom in or out and/or navigate around the application architecture), and/or the level of detail to be displayed for the computing application may additionally or alternatively be updated. The virtual development environment is then updated appropriately (e.g., based on the updated user perspective and/or level of detail) and is further displayed on the virtual reality system.

For example, in some cases, the virtual development environment may be updated to zoom in or out and/or navigate to a particular portion of the application architecture, display a portion of the source code associated with the particular software component, display a virtual keyboard for editing the source code, display a visual indication of the impact of a developer's source code edits on the application architecture, display a visual indication of the call flow of the computing application during execution (e.g., by highlighting or animating the transactions between the underlying components during execution), display additional information for a selected transaction of the call flow, and so forth.

The flowchart may then proceed back to block 512 to cause the updated virtual development environment to be displayed by the virtual reality system.

At this point, the flowchart may be complete. In some embodiments, however, the flowchart may restart and/or certain blocks may be repeated. For example, in some embodiments, the flowchart may repeat blocks 512-516 to continuously monitor the input from the virtual reality system and update the virtual development environment appropriately. Alternatively, or additionally, the flowchart may restart at block 502 to provide a virtual reality development environment for another computing application and/or virtual reality system.

It should be appreciated that the flowcharts and block diagrams in the FIGURES illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order or alternative orders, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as suited to the particular use contemplated.

1. A method, comprising:
accessing source code associated with a computing application, wherein the computing application is executable by one or more processors;
identifying an application architecture associated with the computing application based on an analysis of the source code, wherein the application architecture comprises a plurality of software components and one or more relationships between the plurality of software components;
generating a three-dimensional representation of the application architecture;
identifying a user perspective within a virtual reality system, wherein the user perspective is identified based on an input from the virtual reality system;
generating a virtual development environment for the computing application, wherein the virtual development environment comprises a three-dimensional rendering of the computing application, wherein the three-dimensional rendering is based on the three-dimensional representation of the application architecture and the user perspective within the virtual reality system; and
causing the virtual development environment to be displayed by the virtual reality system.

2. The method of claim 1, wherein generating the virtual development environment for the computing application comprises:
determining a level of detail to be displayed for the computing application, wherein the level of detail varies for different portions of the application architecture based on the user perspective; and
generating the three-dimensional rendering of the computing application based on the level of detail to be displayed.

3. The method of claim 2, wherein determining the level of detail to be displayed for the computing application comprises:
identifying a greater level of detail for portions of the application architecture that are to appear closer to the user perspective and a lesser level of detail for portions of the application architecture that are to appear further from the user perspective.

4. The method of claim 3, further comprising:
detecting a user gesture associated with zooming in or out on the application architecture, wherein the user gesture is detected based on the input from the virtual reality system;
updating the user perspective within the virtual reality system to zoom in or out on the application architecture;
updating the level of detail to be displayed for the computing application based on the updated user perspective; and
updating the virtual development environment based on the updated user perspective and the updated level of detail.

5. The method of claim 1, further comprising:
detecting a user gesture associated with navigating to a particular portion of the application architecture, wherein the user gesture is detected based on the input from the virtual reality system;
updating the user perspective within the virtual reality system to navigate to the particular portion of the application architecture; and
updating the virtual development environment based on the updated user perspective.

6. The method of claim 1, further comprising:
detecting a user gesture associated with selecting a particular software component of the application architecture, wherein the user gesture is detected based on the input from the virtual reality system; and
updating the virtual development environment to display a portion of the source code associated with the particular software component.

7. The method of claim 6, further comprising updating the virtual development environment to display a virtual keyboard for editing the portion of the source code associated with the particular software component.

8. The method of claim 1, further comprising:
detecting one or more edits to the source code in the virtual development environment, wherein the one or more edits are detected based on the input from the virtual reality system;
identifying one or more impacted portions of the application architecture based on the one or more edits to the source code; and
updating the virtual development environment to display a visual indication of the one or more impacted portions of the application architecture.

9. The method of claim 1, further comprising:
executing the computing application;
identifying a call flow during execution of the computing application, wherein the call flow comprises one or more transactions between the plurality of software components during execution of the computing application; and
updating the virtual development environment to display a visual indication of the call flow.

10. The method of claim 9, further comprising:
detecting a user gesture associated with selecting a particular transaction of the call flow, wherein the user gesture is detected based on the input from the virtual reality system; and
updating the virtual development environment to display additional information associated with the particular transaction.

11. The method of claim 1, wherein the virtual development environment further comprises a visual indication of one or more software dependencies associated with the plurality of software components.

12. A non-transitory computer readable medium having program instructions stored therein, wherein the program instructions are executable by a computer system to perform operations comprising:
accessing source code associated with a computing application, wherein the computing application is executable by one or more processors;
identifying an application architecture associated with the computing application based on an analysis of the source code, wherein the application architecture comprises a plurality of software components and one or more relationships between the plurality of software components, wherein the one or more relationships comprise one or more software dependencies;
generating a three-dimensional representation of the application architecture;
identifying a user perspective within a virtual reality system, wherein the user perspective is identified based on an input from the virtual reality system;
generating a virtual development environment for the computing application, wherein:
the virtual development environment comprises a three-dimensional rendering of the computing application, wherein the three-dimensional rendering is based on the three-dimensional representation of the application architecture and the user perspective within the virtual reality system; and
the three-dimensional rendering comprises a varying level of detail for different portions of the application architecture based on the user perspective; and
causing the virtual development environment to be displayed by the virtual reality system.

13. A system, comprising:
one or more processors;
a memory; and
a virtual reality development engine stored in the memory, the virtual reality development engine executable by the one or more processors to:
access source code associated with a computing application;
identify an application architecture associated with the computing application based on an analysis of the source code, wherein the application architecture comprises a plurality of software components and one or more relationships between the plurality of software components;
generate a three-dimensional representation of the application architecture;
identify a first user perspective within a first virtual reality system, wherein the first user perspective is identified based on a first input from the first virtual reality system;
generate a first virtual development environment for the computing application, wherein:
the first virtual development environment comprises a three-dimensional rendering of the computing application, wherein the three-dimensional rendering is based on the three-dimensional representation of the application architecture and the first user perspective within the first virtual reality system; and
the three-dimensional rendering comprises a varying level of detail for different portions of the application architecture based on the first user perspective; and
cause the first virtual development environment to be displayed by the first virtual reality system.

14. The system of claim 13, wherein the system further comprises the first virtual reality system, and wherein the first virtual reality system comprises a virtual reality headset and a virtual reality controller.

15. The system of claim 14, wherein:
the system further comprises a second virtual reality system; and
the virtual reality development engine is further executable by the one or more processors to:
identify a second user perspective within the second virtual reality system, wherein the second user perspective is identified based on a second input from the second virtual reality system;
generate a second virtual development environment for the computing application, wherein the second virtual development environment is generated based on the three-dimensional representation of the application architecture and the second user perspective within the second virtual reality system; and
cause the second virtual development environment to be displayed by the second virtual reality system.

16. The system of claim 15, wherein the virtual reality development engine is further executable by the one or more processors to:
transmit one or more user communications between the first virtual reality system and the second virtual reality system.

17. The system of claim 15, wherein the virtual reality development engine is further executable by the one or more processors to:
detect a command from the second virtual reality system to mirror the first virtual reality system; and
update the second virtual development environment to mirror the first virtual development environment.

18. The system of claim 13, wherein the virtual reality development engine is further executable by the one or more processors to:
detect a user gesture associated with selecting a particular software component of the application architecture, wherein the user gesture is detected based on the first input from the first virtual reality system; and
update the first virtual development environment to display:
a portion of the source code associated with the particular software component; and
a virtual keyboard for editing the portion of the source code associated with the particular software component.

19. The system of claim 13, wherein the virtual reality development engine is further executable by the one or more processors to:
detect one or more edits to the source code in the first virtual development environment, wherein the one or more edits are detected based on the first input from the first virtual reality system;
identify one or more impacted portions of the application architecture based on the one or more edits to the source code; and
update the first virtual development environment to display a visual indication of the one or more impacted portions of the application architecture.

20. The system of claim 13, wherein the virtual reality development engine is further executable by the one or more processors to:
cause the computing application to be executed;
identify a call flow during execution of the computing application, wherein the call flow comprises one or more transactions between the plurality of software components during execution of the computing application; and
update the first virtual development environment to display a visual indication of the call flow.
